(19) United States
(12) Patent Application Publication
(10) Pub. No.: US 2015/0238994 A1
(43) Pub. Date: Aug. 27, 2015

(54) MANUFACTURING APPARATUS OF COATING FILM PRODUCT

(71) Applicant: Panasonic Intellectual Property Management Co., Ltd., Osaka (JP)

(72) Inventors: MASATERU MIKAMI, Osaka (JP); MASASHI HAMABE, Osaka (JP); TAKASHI TSURUTA, Osaka (JP); TAKAO KUROMIYA, Osaka (JP)

(21) Appl. No.: 14/583,287

(22) Filed: Dec. 26, 2014

(30) Foreign Application Priority Data
Feb. 25, 2014 (JP) 2014-034397
Oct. 7, 2014 (JP) 2014-206458

(51) Int. Cl. B05C 1/00

(52) U.S. Cl. CPC B05C 1/00

(57) ABSTRACT

A manufacturing apparatus of a coating film product, which rolls a mixture coating material containing a solvent by using a roll and transfers the mixture coating material to a moving coated object to thereby manufacture the coating film product, in which plural rolls are provided, a surface contact angle between a first roll which transfers the mixture coating material to an adjacent second roll and the solvent is larger than a surface contact angle between a roll surface of the second roll and the solvent concerning the first roll and the second roll in the plural rolls, and the surface contact angle between the roll surface of the second roll and the solvent is larger than a surface contact angle between a coated-object surface of the coated object and the solvent concerning the second roll in the plural roll and the coated object.

### CROSS-REFERENCE TO RELATED APPLICATIONS

The present application claims the benefit of foreign priority of Japanese patent applications 2014-034397 filed on Feb. 25, 2014 and 2014-206458 filed on Oct. 7, 2014, the contents both of which are incorporated herein by reference.

### BACKGROUND

1. Technical Field

The technical field relates to a manufacturing apparatus of a coating film product for manufacturing the coating film product by transferring a coating film material to a moving coated object, for example.

2. Description of Related Art

Recently, applications are becoming multifunctional. For example, applications may be installed on electronic devices, communication devices and cars. Therefore, further output enhancement, capacity enhancement and improvement of mechanical characteristics are increasingly required of electrochemical devices such as a lithium ion battery, a lead storage battery and a capacitor.

In order to improve the performance of the electrochemical device, a method of forming an electrode for the electrochemical device has been improved in various aspects.

The electrode for the electrochemical device can be obtained, for example, by forming an electrode material containing an electrode-active substance and so on in a sheet shape and by crimping the sheet-like electrode composition layer onto a current collector.

It is necessary to form the electrode-active substance in high density for enhancing the capacity of the electrode for the electrochemical device.

### SUMMARY OF THE INVENTION

A related-art manufacturing method of a coating film product will be explained more specifically with reference to FIG. 6.

Here, FIG. 6 is a schematic cross-sectional view of a related-art manufacturing apparatus of the coating film product.

A wet coating material is prepared by mixing and kneading raw materials including an active substance, a conductive material, a binding material and a solvent, and the wet coating material is processed into a sheet-like molded body with a given thickness by roll pressing (for example, refer to JP-A-2012-4059 (Patent Document 1)).

In the above method, as shown in FIG. 6, the coating of forming a film is performed by supplying a wet coating material between a first roll 11 and a second roll 12, and the molded body formed on a coated object 21 as the current collector is fed to directions of arrows B1, B2 and B3 and wound with the coated object 21.

A manufacturing apparatus storing the wet coating material in a space formed by dividers and press-molding the wet coating material by a pair of rolls to obtain the sheet-like molded body is used, thereby improving the density of the active substance and to enhance the capacity, and shortening a drying process to realize high productivity.

However, it is difficult to realize mass production of a uniform coating film product with sufficiently high production efficiency in the related-art manufacturing method of the coating film product.

More specifically, it is difficult to completely transfer the molded body to the current collector according to fabrication conditions concerning types of wet coating materials and so on, and defects may occur in the molded body, therefore, the quality of the electrode for the electrochemical device may be reduced and the production efficiency tends to be reduced.

In view of the above problems, as well as other concerns, a manufacturing apparatus of a coating film product according to various embodiments discussed herein is capable of realizing mass production of the uniform coating film product with higher production efficiency.

According to an embodiment, a manufacturing apparatus of a coating film product rolls a coating film material containing a solvent by using a roll and transfers the coating film material to a moving coated object to thereby manufacture the coating film product, in which plural rolls are provided, a surface contact angle between a roll surface of one roll which transfers the coating film material to the adjacent other roll and the solvent is equal to or larger than a surface contact surface between a roll surface of the other roll and the solvent concerning adjacent two rolls in the plural rolls, and the surface contact angle between the roll surface of the roll which transfers the coating film material to the coated object and the solvent is larger than a surface contact angle between a coated-object surface of the coated object and the solvent concerning the roll which transfers the coating material to the coated object in the plural rolls and the coated object.

In the manufacturing apparatus of the coating film product, surface contact angles between respective roll surfaces and the solvent may be respectively smaller than 150 degrees, and the surface contact angle between the surface of the coated object and the solvent may be larger than 3 degrees.

In the manufacturing apparatus of the coating film product, a roll peripheral velocity ratio V2/V1 as a ratio between a roll peripheral, velocity V2 of the other roll and a roll peripheral velocity V1 of the one roll concerning the adjacent two rolls in the plural rolls may be “1” or more to 30 or less.

In the manufacturing apparatus of the coating film product, a surface contact angle between the roll surface and the solvent at one arbitrary point on the roll surface may be smaller than a surface contact angle between the roll surface and the solvent at another arbitrary point on the roll surface which is positioned outside the one arbitrary point with respect to the roll axis direction.

In the manufacturing apparatus of the coating film product, a surface contact angle between the roll surface and the solvent at one arbitrary point on the roll surface within a given range in accordance with a width of the coated object with respect to a direction orthogonal to a traveling direction may be smaller than a surface contact angle between the roll surface and the solvent at another arbitrary point on the roll surface outside the given range.

In the manufacturing apparatus of the coating film product, a roll surface roughness at one arbitrary point on the roll surface may be smaller than a roll surface roughness at another arbitrary point on the roll surface which is positioned outside the one arbitrary point with respect to the roll axis direction.

In the manufacturing apparatus of the coating film product, a roll surface roughness at one arbitrary point on the roll surface within a given range in accordance with a width of the coated object with respect to a direction orthogonal to a traveling direction may be smaller than a roll surface roughness at another arbitrary point on the roll surface outside the given range.

In the manufacturing apparatus of the coating film product, roll rotation directions of adjacent two rolls in the plural rolls may differ from each other.

In the manufacturing apparatus of the coating film product, a volume water content of the coating film material may be 20 volume or more to 65 volume % or less.

Accordingly, it is possible to provide a manufacturing apparatus of a coating film product capable of realizing mass production of the uniform coating film product with higher production efficiency.

### BRIEF DESCRIPTION OF THE DRAWINGS

FIG. 1 is a schematic cross-sectional view of a manufacturing apparatus of a coating film product according to an embodiment;

FIG. 2 is a schematic partial cross-sectional view of the manufacturing apparatus of the coating film product according to the embodiment;

FIGS. 3A to 3C are explanatory views (No. 1 to No. 3) for explaining operations of the manufacturing apparatus of the coating film product according to the embodiment;

FIG. 4 is a schematic partial cross-sectional view of a manufacturing apparatus of the coating film product according to another embodiment;

FIG. 5 is a partially-cutaway schematic perspective view of a lithium ion secondary battery according to the; and

FIG. 6 is a schematic cross-sectional view of a related-art manufacturing apparatus of the coating film product.

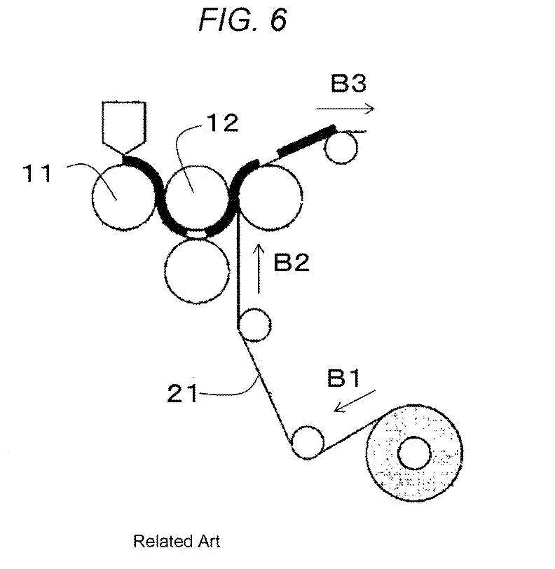

### DESCRIPTION OF EMBODIMENTS

Hereinafter, exemplary embodiments of a manufacturing apparatus of a coating film product will be explained in detail with reference to the drawings.

### Embodiment

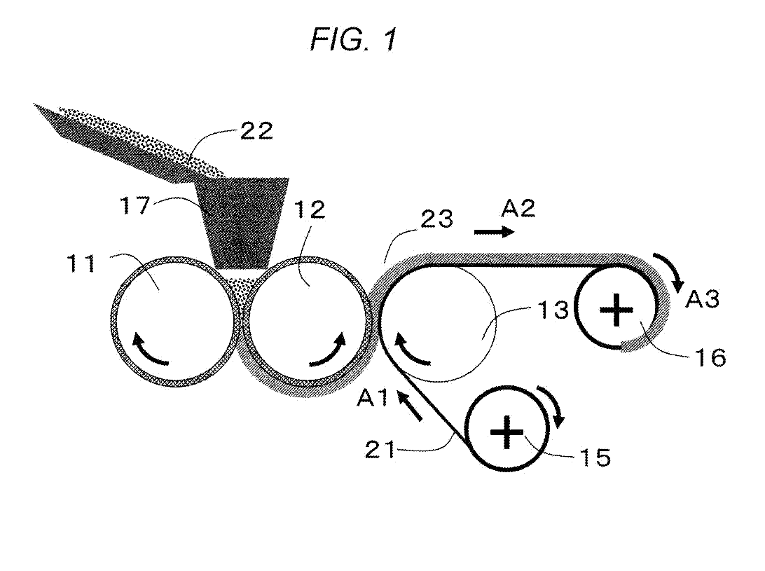

First, a structure and operations of a manufacturing apparatus of a coating film product 23 according to an embodiment will be explained with reference to FIG. 1.

Here, FIG. 1 is a schematic cross-sectional view of the manufacturing apparatus of the coating film product 23 according to the embodiment.

A mixture coating material 22 is supplied to a gap between a first roll 11 and a second roll 12 through a coating material supply hopper 17 installed above a place between the first roll 11 and the second roll 12.

Then, the mixture coating material 22 is transferred in a coating film state on the second roll 12.

A coated object 21 carried along a direction of an arrow A1 from an unwind machine 15 is moved on an upper surface of a third roll 13 along a direction of an arrow A2, and the mixture coating material 22 is transferred in the coating film state between the second roll 12 and the third roll 13.

The coating film product 23 in which the mixture coating material 22 is transferred in the coating film state is wound by a winding machine 16 along a direction of an arrow A3.

Note that post-processes such as a pressing process, a drying process, a peeling process and a slitting process may be performed before the coating film product 23 is wound by the winding machine 16 if necessary.

The next processes such as a laminating process and an assembly process may be performed immediately without winding the coating film product 23 by the winding machine 16.

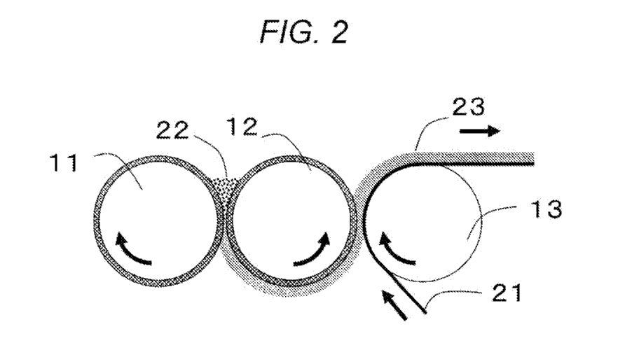

Next, the structure and operations of the manufacturing apparatus of the coating film product 23 according to the embodiment will be explained more specifically with reference to FIG. 2.

Here, FIG. 2 is a schematic partial cross-sectional view of the manufacturing apparatus of the coating film product 23 according to the embodiment.

The mixture coating material 22 is not directly transferred to the coated object 21. First, a coating film is formed on the surface of the second roll 12, then it is transferred to the coated object 21, and the film coating product 23 in which the mixture coating material 22 is transferred in the coating film state to the coated object 23 is moved.

That is, the mixture coating material 22 enters between the first roll 11 and the second roll 12 rotating in a roll rotation direction inverse to a roll rotation direction of the first roll 11.

The coating film is formed on the surface of the second roll 12 first, then, the mixture coating material 22 in the coating film state is transferred from the second roll 12 to the coated object 21 which is moved on an upper surface of the third roll 13.

A roll rotation direction of the third roll 13 is inverse to the roll rotation direction of the second roll 12.

The coated object 21 is moved between the second roll 12 and the third roll 13 at a velocity equal to a roll peripheral velocity of the third roll 13 along the roll rotation direction of the third roll 13.

In order to obtain a better transfer property, the roll rotation direction and the roll peripheral velocity of the first roll 11 and the second roll 12 which are adjacent to each other may be different from each other as well as the roll rotation direction and the roll peripheral velocity of the second roll 12 and the third roll 13 which are adjacent to each other may be different from each other.

It may be preferable that further another roll is provided between the second roll 12 and the third roll 13 according to need.

A material of the first roll 11, the second roll 12 and the third roll 13 is preferably SUS (Steel Use Stainless) and the like having enough rigidity so as not to be adversely affected even in a case where the rigidity of the mixture coating material 22 fluctuates to some degree.

In order to transfer the mixture coating material 22 in the coating film state from the first roll 11 to the second roll 12 as well as in order to transfer the mixture coating material 22 in the coating film state from the second roll 12 to the coated object 21, the surfaces of the first roll 11 and the second roll 12 are preferably covered with materials with an excellent transfer property and so on.

The surfaces of the first roll 11 and the second roll 12 are preferably coated with, for example, (1) polymer materials such as urethane rubber, silicone rubber, fluororubber, chloroprene rubber, nitrile rubber, butyl rubber, PTFE (Polytetrafluoroethylene) sintered body, fluororesin, silicone resin and PEEK (Polyether ether ketone) resin, (2) inorganic materials such as alumina, silica, titania, nickel, chromium, chromium nitride, zirconia, zinc oxide, magnesia, tungsten carbide, DLC (Diamond like carbon) and diamond, (3) metal materials, (4) composite compound materials, (5) fluorine compounds and so on. From the viewpoint of the abrasion property, inorganic materials, metal materials and composite compound materials of the inorganic material and the metal material or fluorine compounds are preferably used.

Other materials besides the above materials may be used as long as such materials have an excellent transfer property.

Then, surface treatments by (1) thermal spraying treatment, (2) impregnated coating of fluororesin, silicone resin and so on or (3) plating and so on may be performed.

Furthermore, the above materials and the surface treatments can be used by itself as well as can be used by mixing or combining them according to need.

Incidentally, the present inventors have found that it is effective to facilitate movement of the mixture coating material 22 from the first roll 11 to the second roll 12 as well as movement from the second roll 12 to the coated object 21 in order to obtain the better transfer property.

Then, the present inventors have found that it is preferable that a surface contact angle θ(1) is equal to or smaller than a surface contact angle θ(2) in a traveling direction, or the surface contact angle θ(2) is smaller than a surface contact angle θ(3) in the traveling direction concerning the surface contact angle θ(1) between the first roll 11 and a solvent of the mixture coating material 22, the surface contact angle θ(2) between the second roll 12 and the solvent of the mixture coating material 22 and the surface contact angle θ(3) between the coated object 21 and the solvent of the mixture coating material 22, namely, that the following relational expressions are satisfied.

θ(1)≧θ(2) (Expression 1)

θ(2)≧θ(3) (Expression 2)

The above will be explained more specifically as follows.

When there is a difference shown in (Expression 1) between the surface contact angles θ(1) and θ(2), the mixture coating material 22 is easily adhered to the surface of the second roll 12 rather than on the surface of the first roll 11, therefore, the mixture coating material 22 hardly remains on the surface of the first roll 11. Even when the surface contact angles θ(1) and θ(2) are equal to each other, the mixture coating material does not remain on the first roll 11 by making a peripheral velocity difference between the first roll 11 and the second roll 12.

Then, when there is a difference shown in (Expression 2) between the surface contact angles θ(2) and θ(3), the mixture coating material 22 is easily adhered to the surface of the coated object 21 rather than the surface of the second roll 12, therefore, the mixture coating material 22 hardly remains on the surface of the second roll 12.

The surface contact angle θ(1) is preferably smaller than 150 degrees.

When the surface contact angle θ(1) is 150 degrees or more, a surface energy on the first roll 11 becomes considerably high. In this case, the surface contact angle θ(1) may be reduced by the abrasion due to long-term use, or a volume-solid content rate of the mixture coating material 22 may be locally reduced as the solvent is unevenly distributed in the mixture coating material 22 as a wet coating material. As a result, the remains of transfer of the mixture coating material 22 may be generated and it may be difficult to completely transfer the mixture coating material 22.

The surface contact angle θ(3) is preferably larger than 3 degrees.

When the surface contact angle θ(3) is 3 degrees or less, the solvent is concentrated at an interface of the contact surface between the coated object 21 and the mixture coating material 22, and the volume-solid content rate of the mixture coating material 22 at the interface is considerably reduced. In this case, the strength of the coating film of the mixture coating material 22 may be reduced. As a result, the remains of the transfer of the mixture coating material 22 may be generated and it may be difficult to completely transfer the mixture coating material 22.

As described above, it is preferable to perform a surface processing treatment to the first roll 11, the second roll 12 and the coated object 21 to adjust the surface contact angle.

In order to obtain the better transfer property, it is preferable that the roll rotation directions and the roll peripheral velocities are different from each other in the first roll 11 and the second roll 12 which are adjacent to each other and it is preferable that the roll rotation directions are different from each other and the roll peripheral velocity is higher than the constant velocity in the second roll 12 and the third roll 13 which are adjacent to each other.

That is, it is preferable that a roll peripheral velocity ratio (the roll peripheral velocity of the second roll 12)/(the roll peripheral velocity of the first roll 11) is larger than “1”, and that (the roll peripheral velocity of the third roll 13/the roll peripheral velocity of the second roll 12) is “1” or more.

In the case where the roll peripheral velocity ratio (the roll peripheral velocity of the second roll 12)/(the roll peripheral velocity of the first roll 11) is “1”, and in the case where (the roll peripheral velocity of the third roll 13)/(the roll peripheral velocity of the second roll 12) is smaller than “1”, it may be difficult to transfer the mixture coating material 22 in the coating film state from the first roll 1 to the second roll 12 as well as from the second roll 12 to the coated object 21.

In the state where the mixture coating material 22 is transferred from the first roll 11 to the second roll 12 as well as from the second roll 12 to the coated object 21, there is little adverse effect even when the roll peripheral velocity ratio (the roll peripheral velocity of the second roll 12)/(the roll peripheral velocity of the first roll 11) and (the roll peripheral velocity of the third roll 13)/(the roll peripheral velocity of the second roll 12) are considerably high, however, the roll peripheral velocity ratio is preferably 30 or less for obtaining a further uniform film thickness.

Concerning surface processing treatments of the first roll 11 and the second roll 12, surface treatments by (1) roughening treatment such as blasting, (2) thermal spraying treatment, (3) impregnated coating of fluororesin, silicone resin and so on or (4) plating and so on may be performed.

Concerning surface processing treatments of the coated object 21, surface treatments by chromate treatment, corona treatment, rust proofing, carbon coating and the like may be performed.

The above materials and the surface treatments can be used by itself as well as can be used by mixing or combining them according to need.

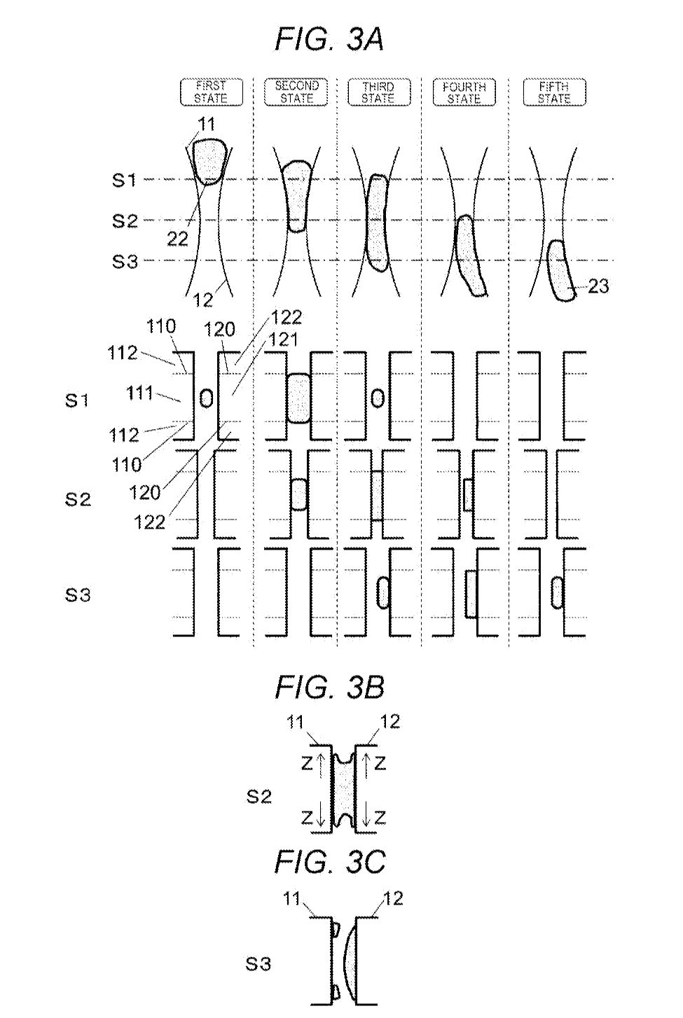

Next, processes in which the mixture coating material 22 is supplied to the first roll 11 and the second roll 12 to form the coating film product 23 will be explained more specifically mainly with reference to FIGS. 3A to 3C.

Here, FIGS. 3A to 3C are explanatory views (No. 1 to No. 3) for explaining operations of the manufacturing apparatus of the coating film product 23 according to the embodiment.

The processes in which the mixture coating material 22 is supplied between the first roll 11 and the second roll 12 to form the film coating product 23 in accordance with time lapse are shown by a first state, a second state, a third state, a fourth state and a fifth state.

Cross-sectional views shown in the upper side of FIG. 3A are cross-sectional views of vertical surfaces, and other cross-sectional views are cross-sectional views of horizontal surfaces S1, S2 and S3.

The horizontal surfaces S1 and S3 are horizontal surfaces corresponding to upper and lower places in the narrowest places of the gap between rolls, and the horizontal surface S2 is a horizontal surface corresponding to the narrowest place of the gap between the rolls.

First, in the first state, the mixture coating material 22 is supplied between the first roll 11 and the second roll 12 from right above the first roll 11 and the second roll 12 in a vertically downward direction.

As a method of supplying the mixture coating material 22, it is preferable to apply a method not causing phenomena such as bridging and rathole in which the coating material does not move between the rolls, so that quantitative and fluid supply can be realized. More specifically, a feeder such as a vibrating feeder, a screw feeder, a rotary feeder, a roll feeder, a belt feeder or an apron feeder is preferably used.

Next, in the second state and the third state, the mixture coating material 22 is fed to the gap between rolls by rotations of the first roll 11 and the second roll 12.

The mixture coating material 22 is rolled while being fed to the gap between the rolls, thereby forming the coating film after passing through the narrowest place of the gap.

The axis of the first roll 11 and the axis of the second roll 12 are allowed to be parallel to each other, and the gap within a given range corresponding to a width of the coated object 21 is formed to have a uniform size with respect to a roll axis direction, thereby obtaining the coating film product 23 which is uniform with respect to the roll axis direction.

The thickness of the coating film can be changed freely by changing the size of the gap.

Next, in the forth state and the fifth state, almost all the formed coating film is transferred from the first roll 11 to the second roll 12 on which the coated object 21 exists.

This is because releasing can be easily performed by the relation of the above-described surface contact angles or the peripheral velocity ratio between rolls.

As the mixture coating material 22 hardly remains on the first roll 11, the coating film product 23 can be continuously formed in the next process after the first roll 11 rotates once.

Incidentally, when the mixture coating material 22 enters the gap between the first roll 11 and the second roll 12 uniformly with respect to the roll axis direction, the uniform film coating product 23 with small variation in film thickness with respect to the roll axis direction can be obtained.

However, in a roll central portion concerning the roll axis direction, the solvent of the mixture coating material 22 as a liquid substance is easily moved as compared with the coated object 21 as a solid substance particularly in a place where the coated object 21 exists, therefore, the solvent moves in directions of arrows Z in the above second and third states (refer to FIG. 3B), and a volume-solid content concentration of the mixture coating material 22 tends to be small in roll end portions outside the roll central portion. Accordingly, remains of transfer may occur at roll end portions of the first roll 12 (refer to FIG. 3C).

When a coating width is widened for reducing the remains of transfer of the mixture coating material 22 with respect to the roll axis direction, the material loss tends to be increased or an equipment price tends to be increased in accordance with increase of sizes of the first roll 11 and the second roll 12.

Accordingly, it is preferable to change the surface contact angle between the first roll 11/the second roll 12 and the solvent of the mixture coating material 22 and the roll surface roughness with respect to the roll axis direction so that the solvent does not easily move to the roll end portions with respect to the roll axis direction.

That is, when the surface contact angle in roll central portions 111 and 121 of the first roll 11 and the second roll 12 is smaller than the surface contact angle in roll both end portions 112 and 122 of the first roll 11 and the second roll 12 (refer to FIG. 3A), preferable effects can be obtained.

When the surface contact angle with respect to the roll axis direction is changed by adjustment of treatment conditions in the above surface processing treatments and the like so that the surface contact angle is smaller in the roll central portions 111 and 112 than in the roll both end portions 112 and 122, the solvent of the mixture coating material 22 hardly moves from the roll central portions 111 and 121 to the roll both end portions 112 and 122 in any of the horizontal surfaces S1, S2 and S3.

Accordingly, uneven distribution of the volume water content of the mixture coating material 22 with respect to the roll axis direction is suppressed in respective states of the above described first state, the second state, . . . , and the fifth state, therefore, the remains of transfer of the mixture coating material 22 hardly occurs in the first roll 12 and the uniform coating film product 23 can be obtained.

Additionally, when the roll surface roughness in the roll central portions 111 and 121 of the first roll 11 and the second roll 12 is smaller than the roll surface roughness in the roll both end portions 112 and 122 in the first roll 11 and the second roll 12 (refer to FIG. 3A), preferable effects can be obtained.

When the roll surface roughness with respect to the roll axis direction is changed by adjustment of treatment conditions such as blasting conditions in the above surface processing treatments so that the roll surface roughness is smaller in the roll central portions 111 and 112 than in the roll both end portions 112 and 122, the solvent of the mixture coating material 22 hardly moves from the roll central portions 111 and 121 to the roll both end portions 112 and 122 in any of the horizontal surfaces S1, S2 and S3.

Accordingly, uneven distribution of the volume water content of the mixture coating material 22 with respect to the roll axis direction is suppressed in respective states of the above described first state, the second state, . . . , and the fifth state, therefore, the remains of transfer of the mixture coating material 22 hardly occurs in the first roll 12 and the uniform coating film product 23 can be obtained.

The surface contact angle tends to be increased as the roll surface roughness is increased, however, the surface contact angle is changed depending on various conditions. For example, the surface contact angle is not always increased when the roll surface roughness is increased.

As described above, preferable effects can be obtained when the surface contact angle between the roll surface and the solvent and the roll surface roughness at one arbitrary point on the roll surface are smaller than the surface contact angle between the roll surface and the solvent and the roll surface roughness at another arbitrary point on the roll surface which is positioned outside the one arbitrary point with respect to the roll axis direction.

Naturally, sufficient effects can be obtained in many cases when the surface contact angle between the roll surface and the solvent and the roll surface roughness at one arbitrary point on the roll surface within a given range in accordance with the width of the coated object 21 are smaller than the surface contact angle between the roll surface and the solvent and the roll surface roughness at another arbitrary point on the roll surface outside the given range.

Meandering of the coated object 21 may occur due to a temporary loosening of tensile force in the coated object 21, winding deviation of a raw sheet of the coated object 21 and so on when the coated object 21 is allowed to travel along the third roll 13.

Such meandering occurs in a small meandering range of approximately 10 mm at most with respect to the roll axis direction in most cases.

However, when positions of boundaries 110 between the roll central portion ill and the roll both end portions 112 in the first roll 11 and positions of boundaries 120 between the roll central portion 121 and the roll both end portions 122 in the second roll 12 are the same as positions of both end portions of the coated object 21, the transfer of the mixture coating material 22 in these positions may become unstable due to the above meandering.

Accordingly, it is preferable that positions of the boundaries 110 and 120 are approximately 10 mm outside positions of both end portions of the coated object 21 with respect to the roll axis direction in consideration of the meandering range.

Then, the transfer of the mixture coating material 22 can be performed more stably with respect to the roll axis direction.

Accordingly, in order to obtain a given mixture weight of an electrode plate (g/m²), it is preferable that the gap between the first roll 11 and the second roll 12 as well as the gap between the second roll 12 and the coated object 21 are adjusted or that a roll peripheral velocity ratio between the first roll 11 and the second roll 12 as well as a roll peripheral velocity ratio between the second roll 12 and the third roll 13 are adjusted.

Furthermore, concerning a volume water concentration of the mixture coating material 22 to be supplied to the gap between the first roll 11 and the second roll 12, a volume water content is preferably 20 volume % or more to 65 volume % or less.

When the volume water content is 20 volume % or more to 65 volume % or less, a solvent exists only on particle surfaces or in the vicinity thereof in the coating material, therefore, the mixture coating material 22 does not have fluidity, and can be formed in the coating film state.

As the fluidity is generated when the volume water content is higher than 65 volume %, the mixture coating material 22 tends to adhere to all the first roll 11, the second roll 12 and the coated object 21.

When the volume water content is lower than 20 volume %, it may be difficult to form the mixture coating material 22 in the coating film state as spaces between particles of the mixture coating material 22 are hardly covered with the solvent.

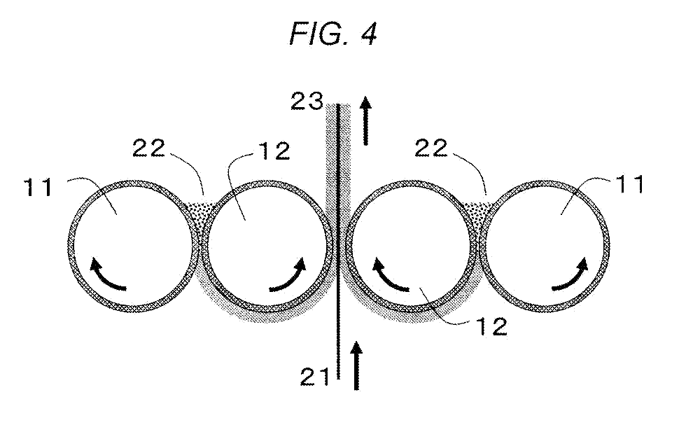

Alternatively, the coating may be performed in both surfaces at the same time as well as may be performed in plural layers successively or at the same time by using the combination of the roll pair including the first roll 11 and the second roll 12 as described above as shown in FIG. 4.

Here, FIG. 4 is a schematic partial cross-sectional view of a manufacturing apparatus of the coating film product 23 according to another embodiment.

As described above, the mixture coating material 22 is supplied to the gap between the first roll 11 and the second roll 12, the coating film is first formed on the surface of the second roll 12 and then the mixture coating material 22 is transferred in the coating film state onto the coated object 21 to thereby form the coating film product 23.

Then, the coating film product 23 goes through various states from a state just after the mixture coating material 22 is transferred onto the coated object 21 to the completion of post-processes such as the pressing process, the drying process and the peeling process.

According to the embodiments, the above coating film product 23 is an example of the coating film product, the mixture coating material 22 is an example of the coating film material and the coated object 21 is an example of the coated object.

According to the embodiments, the first roll 11 and the second roll 12 are examples of adjacent two rolls, the first roll 11 is an example of one roll, and the second roll 12 is an example of the other as well as an example of the roll which transfers the film coating material to the coated object.

In the case where plural pairs of adjacent two rolls are provided, sufficient effects can be obtained in many cases as long as the adjustment of various parameters including the surface contact angle described above is performed with respect to at least one of the plural pairs of rolls.

Furthermore, in the case where plural rolls used for transferring the coating material to the coated object are provided, sufficient effects can be obtained in many cases as long as the adjustment of various parameters including the surface contact angle described above is performed with respect to at least one of the plural rolls.

Hereinafter, examples and comparative examples according to the embodiment based on experiments executed by present inventors will be explained in detail.

### Example 1

The fabrication of a negative electrode plate of a lithium ion secondary battery will be explained in detail.

First, a negative-electrode mixture coating material will be explained.

That is, artificial graphite with 100 pts. volume as an active substance of the negative electrode, styrene-butadiene copolymer rubber particle dispersion with 2.3 pts. volume in terms of solid content of a binding agent with respect to the active substance of 100 pts. volume as the biding agent and carboxymethyl cellulose with 1.4 pts. volume with respect to the active substance of 100 pts. volume as a thickener were stirred with a given amount of water by using a double-arm kneading machine, thereby fabricating a negative-electrode mixture coating material having a volume water content of 50%.

Next, rolls used for fabricating the negative electrode plate will be explained.

The first roll 11, the second roll 12 and the third roll 13 were installed in parallel to one another so that gaps between rolls concerning adjacent rolls were respectively 100 μm (refer to FIG. 2).

A material of the first roll 11, the second roll 12 and the third roll 13 was SUS, and hard chromium plating processing was performed on these surfaces of the rolls.

The roll surfaces of the first roll 11 and the second roll 12 were roughened by blasting, and covered with a DLC film.

The adjustment of treatment conditions in the surface processing treatments was performed so that the surface contact angle between the first roll 11 and the solvent of the mixture coating material 22 was 105 degrees, the surface contact angle between the second roll 12 and the solvent of the mixture coating material 22 was 91 degrees and the surface contact angle between the coated object 21 and the solvent of the mixture coating material 22 was 75 degrees in the roll central portions in the first roll 11, the second roll 12 and the third roll 13 as positions where the coated object travels.

The above adjustment was performed so that (the surface contact angle in the roll central portion)/(the surface contact angle in the roll end portion) was smaller than “1”.

The above adjustment was performed so that (the surface roughness in the roll central portion)/(the surface roughness in the roll end portion) was smaller than “1”.

The coated object 21 traveling between the second roll 12 and the third roll 13 at a velocity equal to the roll peripheral velocity of the third roll 13 was a copper foil with a thickness of 15 μm.

The roll peripheral velocity of the second roll 12 was set to 30 m/minute and the roll peripheral velocity of the third roll 13 was set to 45 m/minute as well as the roll peripheral velocity of the first roll 11 was set so that (the roll peripheral velocity of the second roll 12)/(the roll peripheral velocity of the first roll 11) was 5.

Then, the fabricated negative-electrode mixture coating material was supplied between the first roll 11 and the second roll 12, the coating film was formed on the surface of the second roll 12 and transferred from the second roll 12 to the coated object 21 as the copper foil, then, the solvent was volatilized in the drying process, compression and molding were performed in the pressing process to fabricate the negative electrode plate.

The negative electrode plate was evaluated as follows concerning the transfer property of the coating film.

Whether the mixture coating material 22 was transferred in the coating film state to the coated object 21 which was allowed to travel on the upper surface of the third roll 13 from the first roll 11 through the second roll 12 in good condition or not was measured. Evaluation was performed in four stages in order of excellence, which were denoted by A, B and C indicating transfer properties in which there is no problem at least in practical use, and denoted by D indicating a transfer property in which there are problems in practical use.

Note that Examples 2 to 11 and Comparative Examples 1, 2 differ from Example 1 in conditions concerning fabrication of the negative electrode plate as described below.

### Example 2

The adjustment of treatment conditions in the surface processing treatments was performed so that the surface contact angle between the first roll 11 and the solvent of the mixture coating material 22 was 120 degrees in the roll central portion.

### Example 3

The adjustment of treatment conditions in the surface processing treatments was performed so that the surface contact angle between the coated object 21 and the solvent of the mixture coating material 22 was 15 degrees in the roll central portion.

### Example 4

The adjustment of treatment conditions in the surface processing treatments was performed so that the surface contact angle between the second roll 12 and the solvent of the mixture coating material 22 was 105 degrees in the roll central portion.

### Example 5

The adjustment of treatment conditions in the surface processing treatments was performed so that (the surface contact angle in the roll central portion)/(the surface contact angle in the roll end portion) was 1.1.

### Example 6

The adjustment of treatment conditions in the surface processing treatments was performed so that (the surface roughness in the roll central portion)/(the surface roughness in the roll end portion) was 1.05.

### Example 7

The adjustment of treatment conditions in the surface processing treatments was performed so that the surface contact angle between the first roll 11 and the solvent of the mixture coating material 22 was 160 degrees in the roll central portion.

### Example 8

The adjustment of treatment conditions in the surface processing treatments was performed so that the surface contact angle between the coated object 21 and the solvent of the mixture coating material 22 was 1 degree in the roll central portion.

### Example 9

A negative-electrode mixture coating material with a volume water content of 15% was fabricated.

### Example 10

A negative-electrode mixture coating material with a volume water content of 80% was fabricated.

### Example 11

The roll peripheral velocity of the first roll 11 was set so that (the roll peripheral velocity of the second roll 12)/(the roll peripheral velocity of the first roll 11) was 0.8.

### Example 12

The roll peripheral velocity of the first roll 11 was set so that (the roll peripheral velocity of the second roll 12)/(the roll peripheral velocity of the first roll 11) was 35.

### Comparative Example 1

The adjustment of treatment conditions in the surface processing treatments was performed so that the surface contact angle between the first roll 11 and the solvent of the mixture coating material 22 was 67 degrees in the roll central portion.

### Comparative Example 2

The adjustment of treatment conditions in the surface processing treatments was performed so that the surface contact angle between the second roll 12 and the solvent of the mixture coating material 22 was 67 degrees in the roll central, portion.

Here, experimental results obtained by Examples 1 to 12 and Comparative Examples 1, 2 are shown in Table 1.

TABLE 1

| | surface contact | surface contact | surface contact | (surface contact | surface roughness |
|---|---|---|---|---|---|
| | angle of | angle of | angle of | angle of roll cen- | of roll central |
| | first roll | second roll | coated object | tral portion/(sur- | portion/(surface |
| | central | central | central | face contact angle | roughness of roll |
| item | portion | portion | portion | of roll and potion) | end portion) |
| Example 1 | 105 deg. | 91 deg. | 95 deg. | <1 | <1 |
| Example 2 | 120 deg. | 91 deg. | 75 deg. | <1 | <1 |
| Example 3 | 105 deg. | 91 deg. | 15 deg. | <1 | <1 |
| Example 4 | 105 deg. | 105 deg. | 75 deg. | 1.1 | <1 |
| Example 5 | 105 deg. | 91 deg. | 75 deg. | 1.1 | <1 |
| Example 6 | 105 deg. | 91 deg. | 75 deg. | <1 | 1.05 |
| Example 7 | 160 deg. | 81 deg. | 75 deg. | <1 | <1 |
| Example 8 | 105 deg. | 91 deg. | 1 deg. | <1 | <1 |
| Example 9 | 105 deg. | 91 deg. | 75 deg. | <1 | <1 |
| Example 10 | 105 deg. | 91 deg. | 75 deg. | <1 | <1 |
| Example 11 | 105 deg. | 91 deg. | 75 deg. | <1 | <1 |
| Example 12 | 105 deg. | 91 deg. | 75 deg. | <1 | <1 |
| Comparative | 67 deg. | 91 deg. | 75 deg. | <1 | <1 |
| Example 1 | | | | | |
| Comparative | 105 deg. | 67 deg. | 75 deg. | <1 | <1 |
| Example 2 | | | | | |

| | | (second | | | |
|---|---|---|---|---|---|
| | volume water | roll peripheral | | | coating |
| | content of | velocity/(first | material of | material of | film |
| | coating | roll peripheral | surface of | surface of | transfer |
| item | material | velocity) | first roll | second roll | property |
| Example 1 | 50% | 5 | DLC | DLC | A |
| Example 2 | 50% | 5 | DLC | DLC | A |
| Example 3 | 50% | 5 | DLC | DLC | A |
| Example 4 | 50% | 5 | DLC | DLC | A |
| Example 5 | 50% | 5 | DLC | DLC | A |
| Example 6 | 55% | 5 | DLC | DLC | B |
| Example 7 | 50% | 5 | DLC | DLC | B |
| Example 8 | 50% | 5 | DLC | DLC | B |
| Example 9 | 15% | 5 | DLC | DLC | C |
| Example 10 | 80% | 5 | DLC | DLC | C |
| Example 11 | 50% | 0.8 | DLC | DLC | C |
| Example 12 | 50% | 35 | DLC | DLC | C |
| Comparative | 50% | 5 | SUS | DLC | D |
| Example 1 | | | | | |
| Comparative | 50% | 5 | DLC | SUS | D |
| Example 2 | | | | | |

In Examples 1 to 12,

θ(1)≧θ(2) and (Expression 1)

θ(2)≧θ(3) (Expression 2)

are satisfied, therefore, transfer properties with no problem at least in practical use have been obtained.

In Examples 1 to 4, the adjustment of treatment conditions in the surface processing treatments has been performed so that the (surface contact angle in the roll central portion)/(the surface contact angle in the roll end portion) is smaller than “1” and (the surface roughness in the roll central portion)/(the surface roughness in the roll end portion) is smaller than “1”, therefore, variation in film thickness with respect to the roll axis direction is small.

In Comparative Example 1, as (Expression 1) is not satisfied, the transfer property from the first roll 11 to the second roll 12 is worse, and the mixture coating material 22 remains on the first roll 11.

In Comparative Example 2, as (Expression 2) is not satisfied, the transfer property from the second roll 12 to the coated object 21 is worse, and the mixture coating material 22 remains on the second roll 12.

In Example 5, as (the surface contact angle in the roll central portion)/(the surface contact angle in the roll end portion) is larger than “1”, it is considered that the volume-solid content rate of the mixture coating material 22 has been low in the roll end portion, and the transfer property is slightly worse, therefore, some of the mixture coating material 22 remains on the first roll 11 and the second roll 12.

In Example 6, as (the surface roughness in the roll central portion)/(the surface roughness in the roll end portion) is larger than “1”, it is considered that the volume-solid content rate of the mixture coating material 22 has been low in the roll end portion, and the transfer property is rather worse, therefore, some of the mixture coating material 22 remains on the first roll 11 and the second roll 12.

In Example 7, as the surface contact angle between the first roll 11 and the mixture coating material 22 in the roll central. portion is larger than 150 degrees, the transfer property from the first roll 11 to the second roll 12 is rather worse, therefore, some of the mixture coating material 22 remains on the first roll 11.

In Example 8, as the surface contact angle between the coated object 21 and the solvent of the mixture coating material 22 in the roll central portion is smaller than 3 degrees, the transfer property from the second roll 12 to the coated object 21 is rather worse, therefore, some of the mixture coating material 22 remains on the second roll 12.

In Example 9, as the negative-electrode mixture coating material with a volume water content lower than 20 volume % has been fabricated, the transfer property from the first roll 11 to the second roll 12 is worse and the mixture coating material 22 remains on the first roll 11 or has been fallen.

In Example 10, the negative-electrode mixture coating material with a volume water content higher than 20 volume % has been fabricated, the transfer property from the first roll 11 to the second roll 12 is worse and the mixture coating material 22 remains on the first roll 11 or has been fallen.

In Example 11, as (the roll peripheral velocity of the second roll 12)/(the roll peripheral velocity of the first roll 11) is smaller than “1”, the transfer property from the first roll 11 to the second roll 12 is worse and the mixture coating material 22 remains on the first roll 11.

In Example 12, as (the roll peripheral velocity of the second roll 12)/(the roll peripheral velocity of the first roll 11) is larger than “30”, the transfer property from the first roll 11 to the second roll 12 is worse and the mixture coating material 22 remains on the first roll 11.

As described above, in examples 9 to 12, (Expression 1) and (Expression 2) are satisfied, however, the volume water content of the mixture coating material 22 is not in the range of 20 volume % or more to 65 volume % or less, and (the roll peripheral velocity of the second roll 12)/(the roll peripheral velocity of the first roll 11) is not in a range of 1 or more to 30 or less, therefore, the transfer property of the coating film is not extremely good.

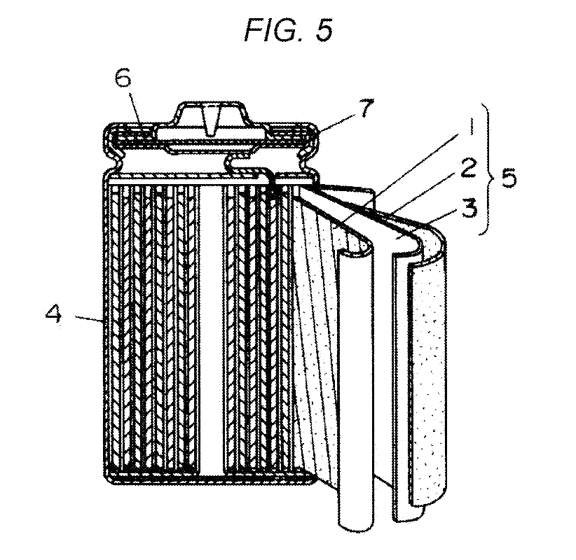

Next, a structure of a lithium ion secondary battery according to the embodiment and a manufacturing method of the lithium ion secondary battery according to the embodiment will be explained with reference to FIG. 5.

Here, FIG. 5 is a partially-cutaway schematic perspective view of the lithium ion secondary battery according to the embodiment of the present invention.

In the perspective views, a longitudinal section of the lithium ion secondary battery having a cylindrical shape is schematically shown by using a partial cutaway.

A negative electrode plate 2 is a negative electrode plate fabricated as described above.

In the assembly of the lithium ion secondary battery, a spiral-shaped electrode plate group 5 winding a positive-electrode plate 1 using a composite lithium oxide as an active substance and the negative electrode plate 2 using a material which can hold lithium as an active substance in a spiral shape through a separator 3 is housed inside a battery case 4 having a bottomed cylindrical shape, and an electrolyte including a given amount of nonaqueous solvent is injected, then, a sealing plate 6 in which a gasket 7 is attached to a rim is inserted into an opening of the battery case 4 and the opening of the battery case 4 is folded in an inner direction to seal the case.

In the lithium ion secondary battery according to the embodiment which uses the electrode plates with small film-thickness variation, the deposition of lithium is suppressed, cycle characteristics and output characteristics are excellent, therefore, it is useful as a power supply for which high output is required.

Therefore, the lithium ion secondary battery according to the embodiment can be used to various apparatuses which require the power supply, which are, for example, (1) electronic apparatuses such as a personal computer, a cellular phone device, a smart phone, a digital still camera, a television and a video camera, (2) electric tools such as an electric drill and a motor screw driver, (3) moving bodies including vehicles such as a wheel chair, a bicycle, a scooter, a motorcycle, a motorcar, an assistive vehicle, electric trains and trains, and (4) a power storage system as a power supply for emergencies.

Needless to say, the manufacturing apparatus of the coating film product 23 according to the embodiment can be used for manufacturing not only secondary batteries such as the lithium ion secondary battery but also resin films for, for example, a capacitor, a ferrite sheet and a water softener or for other functional resin films.

It should be noted that the rolls 11, 12, 13, unwind machine 15 and wind machine 16 of the various embodiment may be rotated by one or more conventional motors, and one or more control devices may be configured according to software or hardware to control the rotation velocities and rotation directions of each of the rolls 11, 12, 13, as well as the unwind machine 15 and wind machine 16. Further, the one or more control devices can control the coating material supply hopper 17 for supplying the mixture coating material 22.

Accordingly, it is possible to form the electrode composition layer directly onto the current collector by a roll-to-roll process, and it is possible to form the uniform coating film product also when using a wet coating material not requiring the drying process of the coating material, which realizes the manufacturing apparatus of the coating film product having high productivity.

Accordingly, the manufacturing apparatus of the coating film product can realize mass production of the uniform coating film product with higher production efficiency, which is useful to be applied for the manufacturing apparatus of the coating film product for manufacturing the coating film product by transferring the coating film material to the coated object which is allowed to continuously travel.

What is claimed is:

1. A manufacturing apparatus of a coating film product, which rolls a coating film material containing a solvent by using a roll and transfers the coating film material to a coated object allowed to travel to thereby manufacture the coating film product,
wherein plural rolls are provided,
a surface contact angle between a roll surface of one roll which transfers the coating film material to the adjacent other roll and the solvent is equal to or larger than a surface contact surface between a roll surface of the other roll and the solvent concerning adjacent two rolls in the plural rolls, and
the surface contact angle between the roll surface of the roll which transfers the coating film material to the coated object and the solvent is larger than a surface contact angle between a coated-object surface of the coated object and the solvent concerning the roll which transfers the coating material to the coated object in the plural rolls and the coated object.

2. The manufacturing apparatus of the coating film product according to claim 1,
wherein surface contact angles between respective roll surfaces and the solvent are respectively smaller than 150 degrees, and
the surface contact angle between the surface of the coated object and the solvent is larger than 3 degrees.

3. The manufacturing apparatus of the coating film product according to claim 1,
wherein a roll peripheral velocity ratio V2/V1 as a ratio between a roll peripheral velocity V2 of the other roll and a roll peripheral velocity V1 of the one roll concerning the adjacent two rolls in the plural rolls is “1” or more to 30 or less.

4. The manufacturing apparatus of the coating film product according to claim 1,
wherein a surface contact angle between the roll surface and the solvent at one arbitrary point on the roll surface is smaller than a surface contact angle between the roll surface and the solvent at another arbitrary point on the roll surface which is positioned outside the one arbitrary point with respect to the roll axis direction.

5. The manufacturing apparatus of the coating film product according to claim 1,
wherein a surface contact angle between the roll surface and the solvent at one arbitrary point on the roll surface within a given range in accordance with a width of the coated object with respect to a direction orthogonal to a traveling direction is smaller than a surface contact angle between the roll surface and the solvent at another arbitrary point on the roll surface outside the given range.

6. The manufacturing apparatus of the coating film product according to claim 1,
wherein a roll surface roughness at one arbitrary point on the roll surface is smaller than a roll surface roughness at another arbitrary point on the roll surface which is positioned outside the one arbitrary point with respect to the roll axis direction.

7. The manufacturing apparatus of the coating film product according to claim 1,
wherein a roll surface roughness at one arbitrary point on the roll surface within a given range in accordance with a width of the coated object with respect to a direction orthogonal to a traveling direction is smaller than a roll surface roughness at another arbitrary point on the roll surface outside the given range.

8. The manufacturing apparatus of the coating film product according to claim 1,
wherein roll rotation directions of adjacent two rolls in the plural rolls differ from each other.

9. The manufacturing apparatus of the coating film product according to claim 1,
wherein a volume water content of the coating film material is volume % or more to 65 volume % or less.
